(19) United States
(12) Patent Application Publication
(10) Pub. No.: US 2024/0211104 A1
(43) Pub. Date: Jun. 27, 2024

(54) METHOD AND DEVICE FOR CONTROLLING VIDEO EDITING UI TO PROVIDE EDIT HISTORY INFORMATION

(71) Applicant: KINEMASTER CORPORATION, Seoul (KR)

(72) Inventor: Jong Deuk KIM, Seongnam-si (KR)

(73) Assignee: KINEMASTER CORPORATION, Seoul (KR)

(21) Appl. No.: 18/557,857

(22) PCT Filed: Apr. 25, 2022
(86) PCT No.: PCT/KR2022/005860

§ 371 Date: Oct. 27, 2023

(30) Foreign Application Priority Data
Apr. 29, 2021 (KR) 10-2021-0055937
Apr. 25, 2022 (KR) 10-2022-0050665

(51) Int. Cl. G06F 3/0482; G11B 27/34

(52) U.S. Cl. CPC G06F 3/0482; G11B 27/34

(57) ABSTRACT

Disclosed herein a video editing user interface (UI) control device. The video editing UI control device includes: an editing UI display unit configured to visualize and display an editing UI including an editing history provision UI on a display device; a user input checking unit configured to check user input information based on user input touch-input through the display device; and an editing UI processing unit configured to generate and manage editing history information based on the user input information provided by the user input checking unit and to provide the editing history information in response to input of the editing history provision UI.

### TECHNICAL FIELD

The present disclosure relates to a method and device for controlling a video editing UI, and more particularly, to a method and device for controlling a video editing UI capable of intuitively processing various functions for video editing.

### BACKGROUND ART

Recently, as portable terminals such as smartphones and tablets have been widely spread, performance of these portable terminals has been improved and wireless communication technology has been developed, users can shoot, edit, and share videos using their portable terminals.

However, in portable terminals, due to limitations in the size of a liquid crystal screen and performance of hardware, users cannot smoothly edit videos as in a general PC environment. In order to improve this inconvenience, user demand for a video editing method that can be used in a portable terminal is increasing.

Furthermore, as the needs of users of portable terminals increase, the performances of camera devices, display devices, and hardware of portable terminals are being upgraded, and many functions or services used in PC environments are being performed by portable terminals. In particular, since portable terminals are basically provided with a camera device, user needs for editing images or videos captured through the camera device are increasing.

Due to the resource characteristics of portable terminals, a video editing method has been popularized so that only limited functions can be used, but editing a video at a level similar to that of a PC environment is required.

Meanwhile, when video editing is performed using an input device such as a mouse device or a keyboard device in a PC environment, a user's action for manipulating the input device needs to be accompanied. In the process of manipulating such an input device, the input device is not operated as desired by the user, which may reduce user convenience.

A portable terminal generally includes a display device supporting touch input. When user input is processed through a display device supporting touch input, the user input can be processed more intuitively and user convenience can be remarkably improved.

### DISCLOSURE

### Technical Problem

An object of the present disclosure is to provide a video editing UI control method and device capable of intuitively processing various functions for video editing.

Another object of the present disclosure is to provide a video editing UI control method and device capable of storing and providing information on an editing history generated when a video project is created.

The technical problems solved by the present disclosure are not limited to the above technical problems and other technical problems which are not described herein will be clearly understood by a person having ordinary skill in the technical field, to which the present disclosure belongs, from the following description.

### Technical Solution

According to the present disclosure, there is provided a video editing user interface (UI) control device, the device comprising: an editing UI display unit configured to visualize and display an editing UI including an editing history provision UI on a display device; a user input checking unit configured to check user input information based on user input touch-input through the display device; and an editing UI processing unit configured to generate and manage editing history information based on the user input information provided by the user input checking unit and to provide the editing history information in response to input of the editing history provision UI.

According to the embodiment of the present disclosure in the device, the editing history information may comprise editing content performed by an editing event of a video project and an index of the editing event.

According to the embodiment of the present disclosure in the device, the editing UI processing unit may be configured to provide a list of editing event units of a video project through the editing history provision UI and to provide details of an editing event selected by the user.

According to the embodiment of the present disclosure in the device, the editing UI processing unit may be configured to sequentially provide details of an editing event of a video project in predetermined time units through the editing history provision UI.

According to the embodiment of the present disclosure in the device, the editing UI processing unit may be configured to, as an editing event is selected by the user on the editing history provision UI, provide information on a progress rate of an editing event indicating a position of the selected editing event.

According to the embodiment of the present disclosure in the device, the editing UI processing unit may configure and provides the editing UI in an editing state corresponding to the editing event as a menu for editing an editing event is selected by the user on the editing history provision UI.

According to the embodiment of the present disclosure in the device, the editing UI processing unit may comprise an editing event detection unit configured to detect an editing event of a video project; and an editing history management unit configured to store and manage the editing event provided from the editing event detection unit and to manage editing history information in units of the video project.

According to the embodiment of the present disclosure in the device, the editing UI processing unit may further comprise an editing history information provision unit configured to provide the editing history information managed by the editing history management unit through the editing history provision UI, in response to the user input information.

According to another present disclosure, there is provided a video editing user interface (UI) control method performed by a computing device comprising at least one processor, the method comprising: visualizing and displaying an editing history provision UI; providing editing history information of a video project through the editing history provision UI; and providing information on at least one editing event included in the editing history information.

### Effects of Invention

According to the present disclosure, it is possible to provide a video editing UI control method and device capable of intuitively processing various functions for video editing.

According to the present disclosure, it is possible to provide an editing UI control method and device that can be used for debugging while sharing editing know-how of a video project by providing and sharing in detail information on the editing history generated when a video project is created.

It will be appreciated by persons skilled in the art that that the effects that can be achieved through the present disclosure are not limited to what has been particularly described hereinabove and other advantages of the present disclosure will be more clearly understood from the detailed description.

### DESCRIPTION OF DRAWINGS

FIG. 1 is a diagram illustrating an electronic device to which various embodiments of the present disclosure are applied.

FIG. 2 is a diagram illustrating a system hierarchy structure of an electronic device to which various embodiments of the present disclosure are applied.

FIG. 3 is a flowchart illustrating a video editing method to which various embodiments of the present disclosure are applied.

FIG. 4 is a diagram illustrating an editing UI provided by a video editing UI control device according to various embodiments of the present disclosure.

FIGS. 5A to 5E are diagrams illustrating a clip editing UI provided by a video editing UI according to various embodiments of the present disclosure.

FIG. 6 is a block diagram illustrating the configuration of a video editing UI control device according to various embodiments of the present disclosure.

FIG. 7 is a diagram illustrating an example of editing history information used in a video editing UI control device according to various embodiments of the present disclosure.

FIG. 8 is a diagram illustrating an example of an editing history provision menu used in a video editing UI control device according to various embodiments of the present disclosure.

FIGS. 9 and 10 are diagrams illustrating examples of an editing history provision menu used in a video editing UI control device according to various embodiments of the present disclosure.

FIG. 11 is a flowchart illustrating a video editing UI control method according to various embodiments of the present disclosure.

### MODE FOR INVENTION

Hereinafter, exemplary embodiments of the present disclosure will be described in detail with reference to the accompanying drawings so that those skilled in the art may easily implement the present disclosure. However, the present disclosure may be implemented in various different ways, and is not limited to the embodiments described therein.

In describing exemplary embodiments of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed embodiments are included in the scope of the present disclosure.

In the present disclosure, elements described in various embodiments do not necessarily mean essential elements, and some of them may be optional elements. Therefore, an embodiment composed of a subset of elements described in an embodiment is also included in the scope of the present disclosure. In addition, embodiments including other elements in addition to the elements described in the various embodiments are also included in the scope of the present disclosure.

Various embodiments of the present disclosure may be implemented in an electronic device having a display unit such as a smartphone or tablet, and a video editing device according to an embodiment of the present disclosure may be implemented by an electronic device having a video editing application. Alternatively, it may be implemented by an electronic device having an image processing unit capable of processing a video and subtitle data and a controller.

Preferably, an electronic device to which various embodiments of the present disclosure are applied means a portable electronic device.

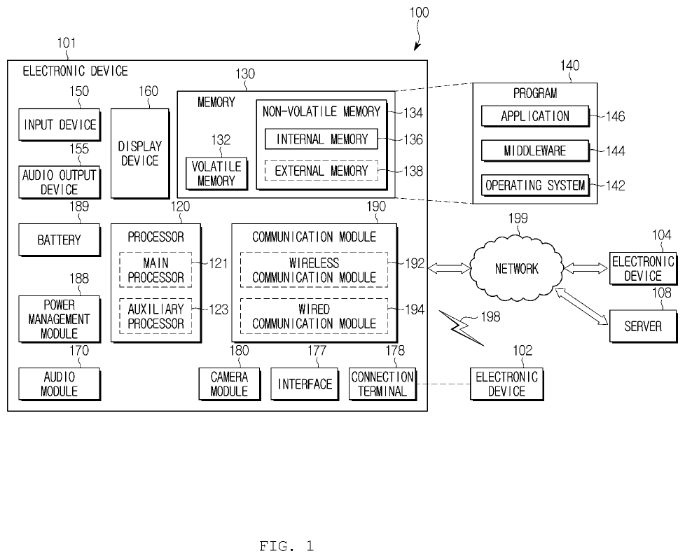

FIG. 1 is a block diagram illustrating an electronic device 101 in a network environment 100, as a diagram illustrating an electronic device to which various embodiments of the present disclosure are applied. Here, the electronic device 101 may be referred to as a computing device, and the electronic device 101 may have a built-in video editing application or an application downloaded from the outside and installed therein.

Referring to FIG. 1, in the network environment 100, the electronic device 101 communicates with an electronic device 102 through a first network 198 (e.g., short-range wireless communication), or communicate with an electronic device 104 or a server 108 through a second network 199 (e.g., a long-distance wireless communication). According to an embodiment, the electronic device 101 may communicate with the electronic device 104 through the server 108. According to an embodiment, the electronic device 101 may include a processor 120, a memory 130, an input device 150, an audio output device 155, a display device 160, an audio module 170, and an interface 177, a camera module 180, a power management module 188, a battery 189, a communication module 190 for transmitting and receiving data through networks 198 and 199, and the like. In another embodiment, in the electronic device 101, at least one of these components (e.g., the display device 160 or the camera module 180) may be omitted or another component may be added.

The processor 120 may, for example, drive software (e.g., program 140) to control at least one other component (e.g., hardware or software component) of the electronic device 101 connected to the processor 120 and perform various data processing and calculations. The processor 120 may load and process commands or data received from another component (e.g., the communication module 190) into a volatile memory 132, and store resultant data in a non-volatile memory 134. According to an embodiment, the processor 120 may include a main processor 121 (e.g., a central processing unit or an application processor) and an auxiliary processor 123 that operates independently of the main processor 121. For example, the auxiliary processor 123 may be additionally or alternatively mounted on the main processor 121 to use less power than the main processor 121. As another example, the auxiliary processor 123 may include an auxiliary processor 123 (e.g., a graphic processing unit, an image signal processor, a sensor hub processor, or a communication processor) specialized for a designated function. Here, the auxiliary processor 123 may be operated separately from or embedded in the main processor 121.

In this case, the auxiliary processor 123 may, for example, control at least some of functions or states related to at least one (e.g., the display device 160 or the communication module 190) of the components of the electronic device 101 in place of the main processor 121, while the main processor 121 is in an inactive (e.g., sleep) state. As another example, while the main processor 121 is in an active (e.g., application execution) state, the auxiliary processor 123, along with the main processor 121, may control at least some of functions or states related to at least components of the electronic device 101.

According to an embodiment, the auxiliary processor 123 (e.g., an image signal processor or a communication processor) may be implemented as a part of another functionally related component (e.g., the camera module 180 or the communication module 190). The memory 130 may store various data, for example, software (e.g., program 140), used by at least one component of the electronic device 101 (e.g., the processor 120) and input data or output data for commands related thereto. The memory 130 may include a volatile memory 132 or a non-volatile memory 134.

The program 140 is software stored in the memory 130, and may include, for example, an operating system 142, middleware 144, or an application 146. The application 146 may include a plurality of software for various functions, and may have a content editing application according to the present disclosure. The editing application is executed by the processor 140 and may be software that creates a new video or selects and edits an existing video.

The input device 150 is a device for receiving a command or data to be used in a component (e.g., the processor 120) of the electronic device 101 from the outside (e.g., a user) of the electronic device 101, and may include, for example, a microphone, a mouse or a keyboard.

The audio output device 155 may be a device for outputting a sound signal to the outside of the electronic device 101. For example, the audio output device 155 may include a speaker used for general purposes such as playing multimedia or recording, and a receiver used exclusively for receiving calls. According to one embodiment, the receiver may be formed integrally with or separately from the speaker.

The display device 160 may be a device for visually providing information to the user of the electronic device 101. The display device 160 may include, for example, a display, a hologram device, or a projector and a control circuit for controlling the device. According to an embodiment, the display device 160 may include a touch circuitry or a pressure sensor capable of measuring the strength of a touch pressure. The display device 160 may detect the coordinates of a touch input area, the number of touch input areas, a touch input gesture, etc. based on the touch circuitry or the pressure sensor, and transmit the detected result to the main processor 121 or the auxiliary processor 123.

The audio module 170 may convert bidirectionally sound and electrical signals. According to an embodiment, the audio module 170 may obtain sound through the input device 150 or output sound through an external electronic device (e.g., an electronic device 102 (e.g., speaker or headphone)) connected to the electronic device 101 by wire or wirelessly.

The interface 177 may support a designated protocol capable of connecting to an external electronic device (e.g., the electronic device 102) by wired or wirelessly. According to one embodiment, the interface 177 may include a high definition multimedia interface (HDMI), a universal serial bus (USB) interface, an SD card interface, or an audio interface.

A connection terminal 178 is a connector capable of physically connecting the electronic device 101 and the external electronic device (e.g., the electronic device 102), for example, an HDMI connector, a USB connector, an SD card connector, or an audio connector (e.g., headphone connector).

The camera module 180 may capture still images and moving images. According to one embodiment, the camera module 180 may include one or more lenses, image sensors, image signal processors, or flashes.

The power management module 188 is a module for managing power supplied to the electronic device 101, and may be configured as at least a part of a power management integrated circuit (PMIC).

The battery 189 is a device for supplying power to at least one component of the electronic device 101, and may include, for example, a non-rechargeable primary battery, a rechargeable secondary battery, or a fuel cell.

The communication module 190 may support establishment of a wired or wireless communication channel between the electronic device 101 and the external electronic device (e.g., the electronic device 102, the electronic device 104, or the server 108) and performance of data communication through the established communication channel. The communication module 190 may include one or more communication processors that support wired communication or wireless communication that are operated independently of the processor 120 (e.g., an application processor). According to an embodiment, the communication module 190 includes a wireless communication module 192 (e.g., a cellular communication module, a short-range wireless communication module, or a global navigation satellite system (GNSS) communication module) or a wired communication module 194 (e.g., a local area network (LAN) communication module or a power line communication module), and, using a corresponding communication module among them, may communicate with the external electronic device through a first network 198 (e.g., a short-range communication network such as Bluetooth, Bluetooth low energy (BLE), Wi-Fi direct, or infrared data association (IrDA)) or a second network 199 (e.g., a long-distance network such as a cellular network, the Internet, or a computer network (e.g., LAN or WAN)). The above-described various types of the communication modules 190 may be implemented as a single chip or may be implemented as separate chips.

Some of the above components may be connected to each other through a communication method between peripheral devices (e.g., a bus, GPIO (general purpose input/output), SPI (serial peripheral interface), or MIPI (mobile industry processor interface)) to exchange signals (e.g. commands or data) with each other.

According to an embodiment, commands or data may be transmitted or received between the electronic device 101 and the external electronic device 104 through the server 108 connected to the second network 199. Each of the electronic devices 102 and 104 may be the same as or different from the electronic device 101. According to an embodiment, at least some of the operations executed in the electronic device 101 may be executed in another or a plurality of external electronic devices. According to an embodiment, when the electronic device 101 needs to perform a specific function or service automatically or upon request, the electronic device 101 may request at least some functions associated with the function or service from the external electronic device instead of or additional to executing the function or service by itself. The external electronic device, which has received the request, may execute the requested function or additional function and deliver the result to the electronic device 101. The electronic device 101 may provide the requested function or service by processing the received result without change or additionally. To this end, for example, cloud computing, distributed computing, or client-server computing technology may be used.

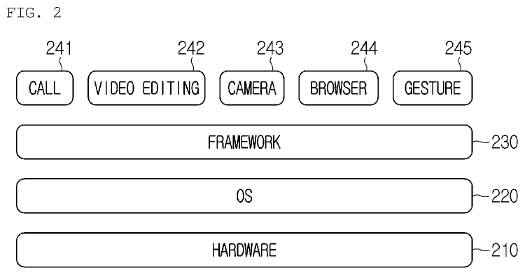

FIG. 2 is a diagram for explaining a system hierarchy structure of an electronic device to which various embodiments of the present disclosure are applied.

Referring to FIG. 2, an electronic device 200 may include a hardware layer 210 corresponding to the electronic device 100 of FIG. 1 described above, and an operating system (OS) layer 220 that manages the hardware layer 210 as a higher layer of the hardware layer 210, a framework layer 230 as a higher layer of the OS layer 220, and an application layer 240.

The OS layer 220 controls overall operations of the hardware layer 210 and performs a function of managing the hardware layer 210. That is, the OS layer 220 is in charge of basic functions such as hardware management, memory, and security. The OS layer 220 may include drivers for operating or driving hardware devices included in the electronic device, such as a display driver for driving a display device, a camera driver for driving a camera module, and an audio driver for driving an audio module. In addition, the OS layer 220 may include a library and a runtime that developers may access.

The framework layer 230 exists as a higher layer of the OS layer 220, and the framework layer 230 serves to connect the application layer 240 and the OS layer 220. That is, the framework layer 230 includes a location manager, a notification manager, and a frame buffer for displaying an image on the display unit.

The application layer 240 implementing various functions of the electronic device 100 is located above the framework layer 230. For example, the application layer 240 may include various application programs such as a call application 241, a video editing application 242, a camera application 243, a browser application 244, and a gesture application 245.

Furthermore, the OS layer 220 may provide a menu or UI capable of adding or deleting at least one application or application program included in the application layer 240, and through this, at least one application or application program included in the application layer 240 may be added or deleted by the user. For example, as described above, the electronic device 100 of FIG. 1 may be connected to the other electronic devices 102 and 104 or the server 108 through communication, and may receive data (that is, at least one application or application program) provided from the other electronic devices 102 and 104 or the server 108 by the request of the user and store it in the memory. At this time, at least one application or application program stored in the memory may be configured and operated in the application layer 240. In addition, at least one application or application program may be selected by the user using the menu or UI provided by the OS layer 220, and the selected at least one application or application program may be deleted.

Meanwhile, when a user control command input through the application layer 240 is input to the electronic device 100, it may be transferred from the application layer 240 to the hardware layer 210 to execute a specific application corresponding to the input control command, and the result may be displayed on the display device 160.

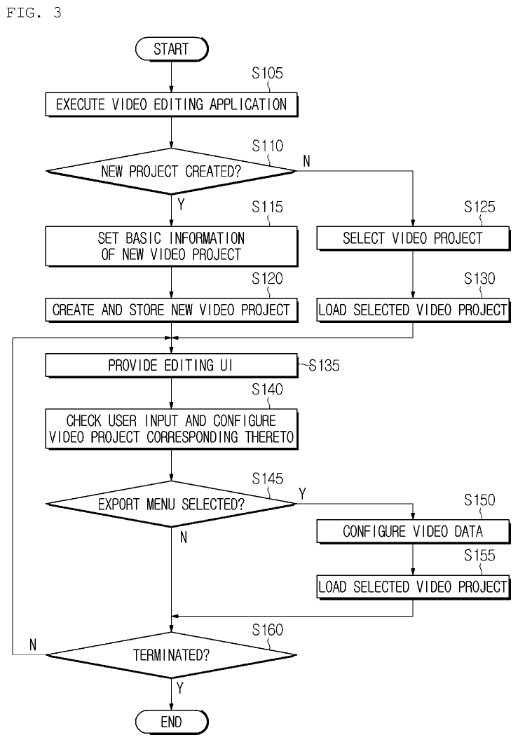

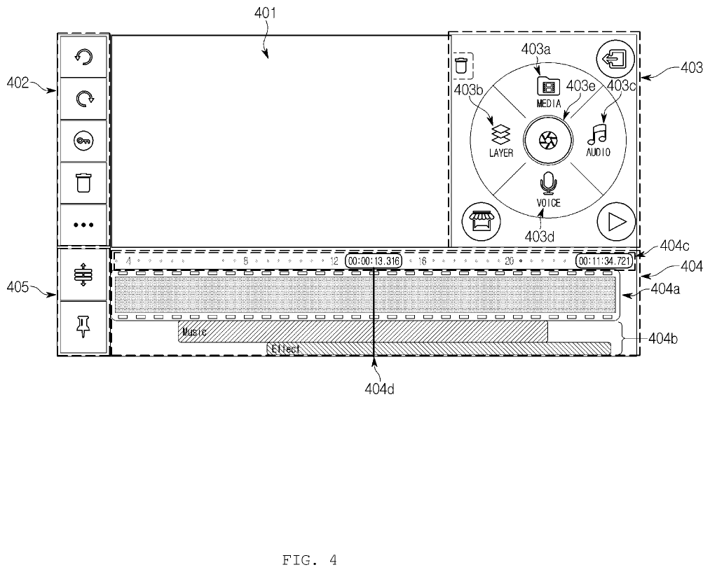

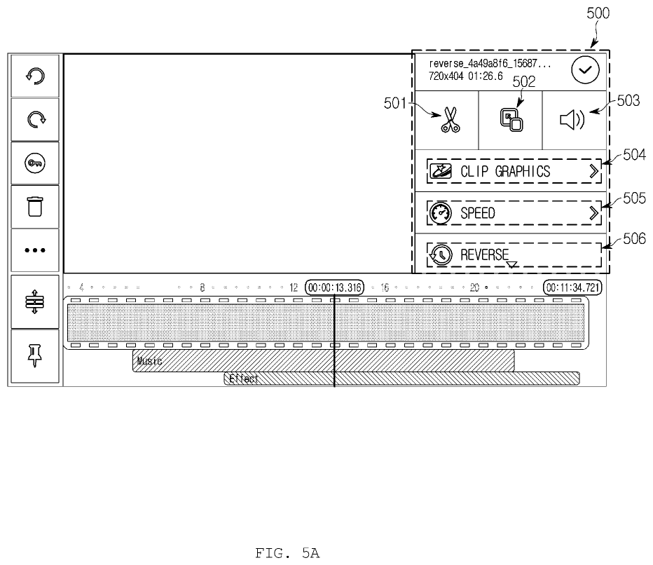

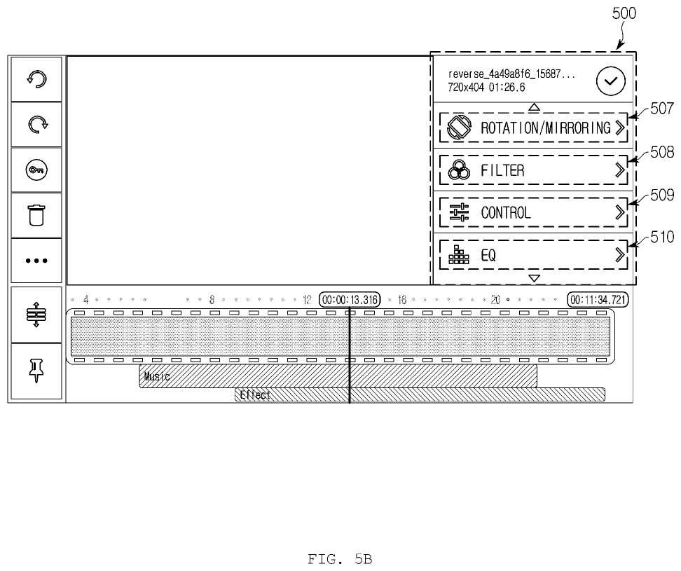

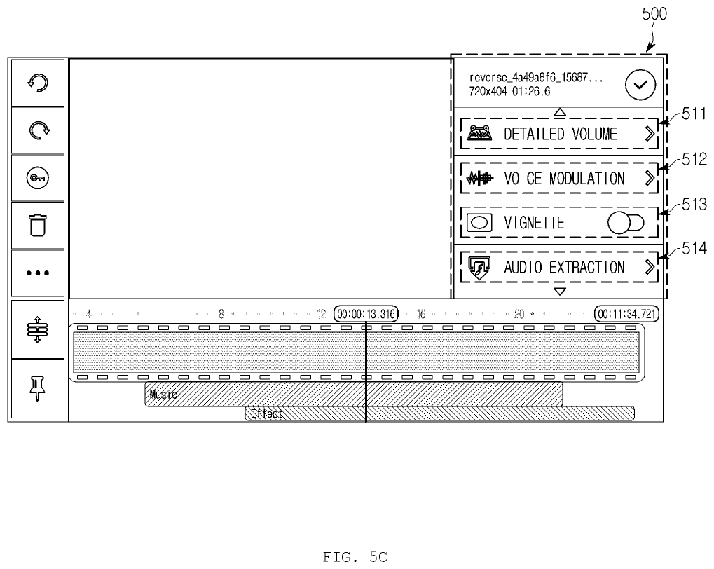

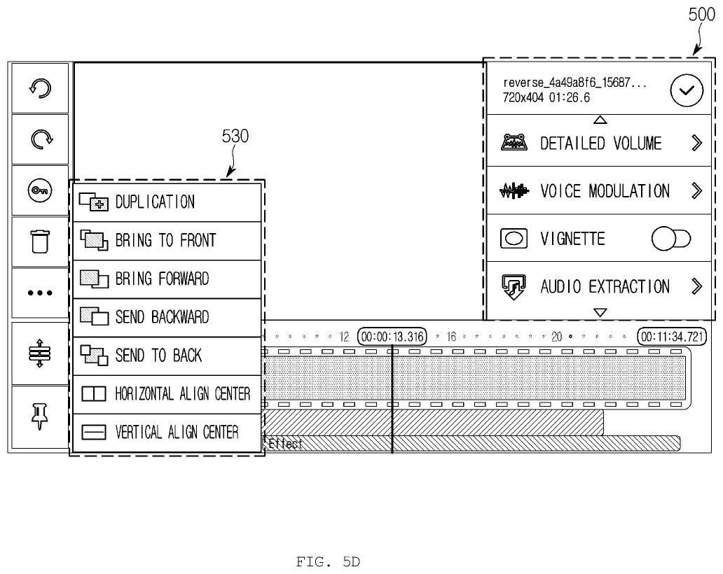

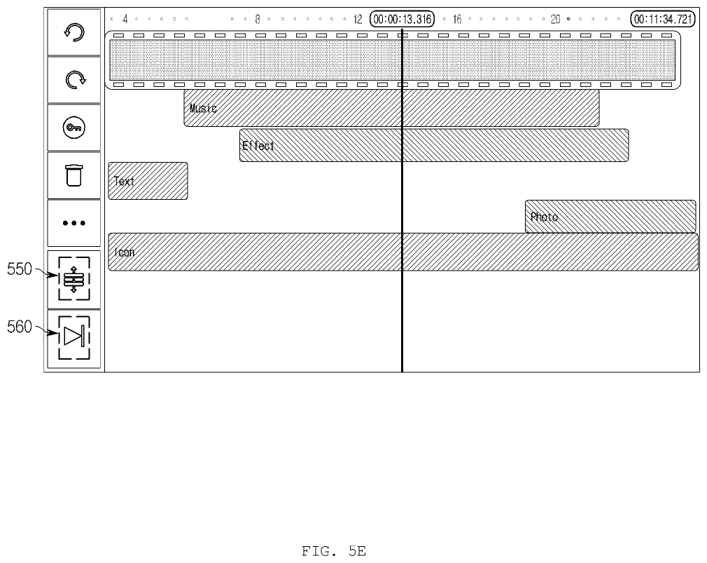

FIG. 3 is a flowchart illustrating a video editing method to which various embodiments of the present disclosure are applied.

Referring to FIG. 3, first, the video editing method may be operated by the above-described electronic device (or computing device), and the operation may be initiated as a video editing application is selected and executed by user input (S105).

When the video editing application is executed, the electronic device may output an initial screen of the video editing application to a display device (e.g., a display). A menu (or UI) for creating a new video project and a video project selection menu (or UI) for selecting a video project being edited in advance may be provided on the initial screen. On this initial screen, when the menu (or UI) for creating the new video project is selected by the user, the process may proceed to step S115, and when the video project selection menu (or UI) is selected, the process may proceed to step S125 (S110).

In step S115, the electronic device may provide a menu (or UI) for setting basic information of a new video project, and set and apply the basic information input through the menu (or UI) to the new video project. For example, the basic information may include an aspect ratio of the new video project. Based on this, the electronic device may provide a menu (or UI) capable of selecting an aspect ratio such as 16:9, 9:16, 1:1, etc., and an aspect ratio input through the menu (or UI) may be set and applied to the new video project.

Thereafter, the electronic device may create a new video project by reflecting the basic information set in step S115, and store the created new video project in a storage medium (S120).

Although the aspect ratio is exemplified as basic information in one embodiment of the present disclosure, the present disclosure is not limited thereto, and may be variously changed by a person having ordinary knowledge in the technical field of the present disclosure. For example, the electronic device may provide a menu (or UI) capable of setting at least one of automatic control of a master volume, the size of the master volume, audio fade-in default setting, audio fade-out default settings, video fade-in default settings, video fade-out default settings, default settings of an image clip, default settings of a layer length or pan & zoom default settings of the image clip, and a value input through the menu (or UI) may be set as the basic information of the new video project.

As another example, the electronic device may automatically set the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan & zoom default settings of the image clip to predetermined values. In addition, the electronic device may provide a setting menu (or UI), receive control values of the aspect ratio, automatic control of the master volume, the size of the master volume, the audio fade-in default settings, the audio fade-out default settings, the video fade-in default settings, the video fade-out default settings, the default settings of the image clip, the default settings of the layer length, and the pan & zoom default settings of the image clip through the setting menu (or UI), and set the above-described default information according to the received values.

Meanwhile, in step S125, the electronic device may provide a project list including video projects stored in a storage medium and provide an environment in which at least one video project included in the project list may be selected. Through the above-described environment, the user may select at least one video project included in the project list, and the electronic device may load the at least one video project selected by the user (S130).

In step S135, the electronic device may provide an editing UI. The editing UI may include a video display window 401, a media setting window 402, a media input window 403, a clip display window 404, a clip setting window 405, and the like. In the editing UI, the video display window, the media setting window, and the media input window may be displayed on an upper portion of the display, and the clip display window and the clip setting window may be displayed on a lower portion of the display.

The media setting window may include an export menu, a capture menu, a setting menu, and the like, and the export menu, the capture menu, and the setting menu may be provided in the form of icons or text capable of recognizing the corresponding menu.

The media input window may include a media input menu 403a, a layer input menu 403b, an audio input menu 403c, a voice input menu 403d, a shooting menu 403e, and the like, and the media input menu 403a, the layer input menu 403b, the audio input menu 403c, the voice input menu 403d, and the shooting menu 403e may be provided in the form of icons or text capable of recognizing the corresponding menu. Also, each menu may include a sub-menu, and as each menu is selected, the electronic device may compose and display a sub-menu corresponding thereto.

For example, the media input menu 403a may be connected to the media selection window as a sub-menu, and the media selection window may provide an environment capable of selecting media stored in a storage medium. Media selected through the media selection window may be inserted and displayed in the clip display window. The electronic device may check the type of media selected through the media selection window, set the clip time of the media in consideration of the checked type of the media, insert and display it in the clip display window. Here, the type of media may include images, videos, and the like. If the type of media is an image, the electronic device may check a default length setting value of the image clip and set an image clip time according to the default length setting value of the image clip. In addition, if the type of media is a video, the electronic device may set the time of the video clip according to the length of the corresponding media.

As a sub-menu of the layer input menu 403b, a media input menu, an effect input menu, an overlay input menu, a text input menu, a media input menu, and a drawing input menu may be included.

The media input menu may be configured in the same way as the aforementioned media input menu.

The effect input menu may provide an environment in which blur effect, mosaic effect, noise effect, sandstorm effect, melting point effect, crystal effect, star filter effect, display board effect, haze effect, fisheye lens effect, magnifying lens effect, flower twist effect, night vision effect, sketch effect, etc. may be selected. An effect selected through the effect input menu may be inserted and displayed in the clip display window. At this time, the electronic device may check the default setting value of the layer length and set the effect clip time according to the default setting value of the layer length.

The overlay input menu may provide an environment in which stickers and icons of various shapes or shapes may be selected. The stickers, icons, etc. selected through the overlay input menu may be inserted and displayed in the clip display window. At this time, the electronic device may check the default setting value of the layer length and set the clip times of stickers, icons, etc. according to the default setting value of the layer length.

The text input menu may provide an environment in which text may be input, for example, a Qwerty keyboard. The text input through the text input menu may be inserted and displayed in the clip display window. At this time, the electronic device may check the default setting value of the layer length and set the text clip time according to the default setting value of the layer length.

The drawing input menu may be configured to provide a drawing area in the image display window and to display a drawing object in a touch input area in the image display window. The handwriting input menu may include a drawing tool selection menu for selecting a drawing tool, a color selection menu for selecting a drawing color, a thickness setting menu for setting the thickness of a drawing object, a partial deletion menu for deleting a created drawing object, and a delete-all menu for deleting all drawn objects as sub-menus. In addition, when the handwriting input menu is selected, the electronic device may check the default setting value of the layer length and set the drawing object clip time according to the default setting value of the layer length.

The audio input menu 403c may be connected to the audio selection window as a sub-menu, and the audio selection window may provide an environment in which an audio file stored in a storage medium may be selected. An audio file selected through the audio selection window may be inserted and displayed in the clip display window.

The voice input menu 403d may be a menu for recording sound input through a microphone. When the voice input menu is selected by the user, the electronic device may activate the microphone provided in the device to detect a voice signal input through the microphone. In addition, the electronic device may display a recording start button, and when the recording start button is input, recording of the voice signal may be started. Furthermore, the electronic device may visualize and display the voice signal input through the microphone. For example, the electronic device may check the amplitude or frequency characteristics of the voice signal and display the checked characteristics in the form of a level meter or a graph.

The shooting menu 403e may be a menu for capturing an image or video input through a camera module included in the electronic device. The shooting menu 403e may be displayed through an icon visualizing a camera device. The shooting menu 403e may include an image/video shooting selection menu for selecting a camera for capturing an image or a camcorder for capturing a video as a sub-menu thereof. Based on this, when the shooting menu 403e is selected by the user, the electronic device may display an image/video shooting selection menu. In addition, the electronic device may activate an image capturing mode or a video capturing mode of the camera module according to selection through the image/video capturing selection menu.

The clip display window 404 may include at least one clip line displaying a clip corresponding to media, effect, overlay, text, drawing, audio, voice signal, etc. input through the media input window.

The clip line may include a main clip line 404a and a sub clip line 404b, and a clip line provided at the uppermost end of the clip display window is referred to as the main clip line 404a, and at least one clip line provided under the main clip line 404a may be referred to as the sub clip line 404b.

The electronic device may fix and display the main clip line 404a at the uppermost end of the clip display window, check drag input based on an area where the sub clip line 404b exists, and scroll the sub clip line 404b up and down according to a drag input direction.

Furthermore, when the drag input direction is checked as an upward direction, the electronic device may move and display the sub clip line 404b to an upper area, and when the drag input direction is checked as a downward direction, the electronic device may move and display the sub clip line 404b to a lower area. In addition, the electronic device may display the height of the main clip line 404a differently according to the movement of the sub clip line 404b. For example, when the sub clip line 404b moves upward, the height of the main clip line 404a may be decreased and displayed, and when the sub clip line 404b moves downward, the height of the main clip line 404a may be increased and displayed.

In particular, the clip display window may include a time display line 404c indicating the time of the video project and a play head 404d. The time display line 404c may be displayed above the main clip line 404a described above, and may include a scale or number in a predetermined unit. In addition, the play head 404d may be displayed as a line starting from the time display line 404c and vertically connected to the lower end of the clip display window, and may be displayed in a color (e.g., red) that can be easily recognized by the user.

Furthermore, the play head 404d may be provided in a fixed form in a predetermined area, and the objects included in the main clip line 404a and the sub clip line 404b provided in the clip display window and the time display line 404c may be configured to be movable in the left and right directions.

For example, when drag input is generated in the left and right directions in an area where the main clip line 404a, the sub clip line 404b, and the time display line 404c are located, the electronic device may move and display the objects included in the main clip line 404a and the sub clip line 404b and the time display line 404c in the left and right directions. In this case, the electronic device may be configured to display a frame or object corresponding to the play head 404d in the image display window. In addition, the electronic device may check a detailed time (e.g., in units of 1/1000 second) that the play head 404d touches, and display the checked detailed time together in the clip display window.

In addition, the electronic device may check whether a multi-touch has occurred in the clip display window, and if a multi-touch has occurred, a scale or number of a predetermined unit included in the time display line 404c may be changed and displayed in response to the multi-touch. For example, when input in which a multi-touch interval gradually decreases is confirmed, the electronic device may decrease the interval between scales or numbers. When input in which the multi-touch interval gradually increases is confirmed, the electronic device may increase and display the interval between scales or numbers.

The electronic device may configure the clip display window 404 so that a clip displayed on the clip line may be selected, and when a clip is selected, it may visualize and display that the corresponding clip has been selected. For example, when selection of a clip is detected, the electronic device may provide a clip selector to a boundary of the selected clip, and the clip selector may be displayed in a predetermined color, for example, yellow.

Preferably, when selection of a clip is detected, the electronic device may provide a clip editing UI capable of editing the selected clip. For example, the electronic device may display a clip editing UI in an area where the media input window 403 exists. The clip editing UI may be set differently according to the type of the selected clip. Specifically, when the type of clip is a video clip, the electronic device may configure and provide a clip editing UI 500, by including a trim/split menu 501, a pan/zoom menu 502, an audio control menu 503, a clip graphic menu 504, and a speed control menu 505, a reverse control menu 506, a rotation/mirroring control menu 507, a filter menu 508, a brightness/contrast control menu 509, a voice EQ control menu 510, a detailed volume control menu 511, a voice modulation menu 512, a vignette control menu 513, an audio extraction menu 514, and the like.

The clip editing UI for each type of clip may be configured based on the structure of the video editing UI.

Additionally, the electronic device may further display a clip editing expansion UI 530 in an area where the media setting window exists. The clip editing expansion UI displayed in the area of the media setting window may also be set differently according to the type of the selected clip. For example, when the type of clip is a video clip, an image clip, an audio clip, or an audio signal clip, the electronic device may configure and provide the clip editing expansion UI 530 by including a clip deletion menu, a clip duplication menu, a clip layer duplication menu, and the like. If the type of clip is a video clip, image clip, audio clip, or audio signal clip, the electronic device may configure and provide the clip editing expansion UI 530 by including the clip deletion menu, the clip duplication menu, the clip layer duplication menu, and the like, and if it is an effect clip, text clip, overlay clip, or drawing clip, the electronic device may configure and provide the clip editing expansion UI by including a clip deletion menu, a clip duplication menu, a bring-to-front menu, a bring-forward menu, a send-backward menu, a send-to-back menu, a horizontal align center menu, a vertical align center menu and the like.

The clip setting window may include a clip enlargement display menu 550 and a clip movement control menu 560. When the clip display menu 550 is selected by the user, the electronic device may enlarge and display the clip display window to the entire area of the display. Also, when the clip movement control menu 560 is selected, the electronic device may move and display the clip according to the play head. Furthermore, the clip movement control menu 560 may include a start area movement menu or an end area movement menu, and it is preferable that the start area movement menu or end area movement menu may be adaptively displayed in consideration of the position of the play head touching the clip. For example, the electronic device basically provides the start area movement menu, and when a clip touches a starting position of the play head, the start area movement menu may be replaced with the end area movement menu and displayed.

In step S140, the electronic device may check user input input through the editing UI, configure a video project corresponding to the user input, and store the configured video project in a storage medium.

As described above, the editing UI is configured to include an export menu in the media setting window. When the export menu is selected by the user (Y in S145), the electronic device may configure video data by reflecting the information configured in the video project and store it in a storage medium (S150).

The structure of the editing UI provided by the device for controlling the video editing UI according to various embodiments of the present disclosure may be configured as follows.

First of all, the editing UI may basically include a video display window 401, a media setting window 402, a media input window 403, a clip display window 404, a clip setting window 405, and the like. At least one clip selected through the media input window 403 may be displayed on the clip display window 404. In addition, as at least one clip 404a or 404b included in the clip display window 404 is selected, clip editing menus 501, 502, . . . 514 may be provided in the area where the media input window 403 exists. At this time, the clip editing menus 501, 502, . . . 514 may be provided adaptively according to the structure of the editing UI for each clip type.

The video clip editing menu may include a trim/split menu, a pan/zoom menu, an audio control menu, a clip graphic menu, a speed control menu, a reverse control menu, a rotation/mirroring menu, a filter menu, a brightness/contrast/gamma control menu, a voice EQ control menu, a detailed volume control menu, a voice modulation control menu, a vignetting ON/OFF control menu, an audio extraction menu, and the like.

The trim/split menu may include a trim menu on the left of the play head, a trim menu on the right of the play head, a split menu on the play head, a still image split and insert menu, and the like, as sub-menus.

The audio control menu may include a master volume control bar, a sound effect volume control bar, an automatic volume ON/OFF menu, a left/right balance control bar, a pitch control bar, and the like, as sub-menus. In addition, the master volume control bar, the sound effect volume control bar, the left/right balance control bar, the pitch control bar, and the like may be set to support a detailed control UI, and the master volume control bar, the sound effect volume control bar, the left/right balance control bar, the pitch control bar and the like may be managed through the main editing UI. A UI set as the main editing UI may be configured to display a detailed control UI together. As another example, when touch input is generated for more than a predetermined time (e.g., 1 second) in an area where the main editing UI set to support the detailed control UI exists, the detailed control UI may be activated as a sub-menu.

The clip graphic menu may be configured to select at least one graphic to be inserted into the clip.

The speed control menu may include at least one predetermined speed control button (e.g., 1×, 4×, 8×), a speed control bar, a mute ON/OFF menu, a pitch maintenance ON/OFF menu, and the like. Also, the speed control bar may be managed as a main editing UI.

The reverse control menu may be configured to perform reverse processing of a video included in a corresponding clip.

The voice EQ control menu may be configured to select at least one voice EQ to be applied to a video.

The filter menu may be configured to select at least one video filter to be applied to the video.

The brightness/contrast/gamma control menu may include a brightness control bar, a contrast control bar, a gamma control bar and the like as sub-menus so as to control the brightness/contrast/gamma value of the video, and the brightness control bar, the contrast control bar, and the gamma control bar and the like may be managed as a main editing UI and set to support the detailed control UI.

The rotation/mirroring menu may include a horizontal mirroring menu, a vertical mirroring menu, a counterclockwise rotation menu, a clockwise rotation menu and the like as sub-menus, and the counterclockwise rotation menu and clockwise rotation menu may be managed as a main editing UI and set to support the detailed control UI.

The detailed volume control menu is a menu for controlling the volume of audio included in the video, and may include a control point addition menu, a control point deletion menu, a voice control bar and the like. The voice control bar may be managed as a main editing UI and set to support the detailed control UI.

The voice modulation control menu may be configured to select at least one voice modulation method to be applied to the video.

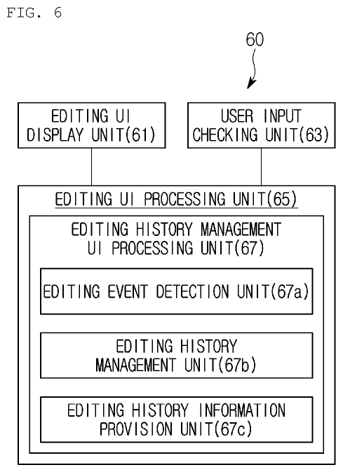

Meanwhile, the image clip editing menu may include a trim/split menu, a pan/zoom menu, a rotation/mirroring control menu, a clip graphic menu, a filter menu, a brightness/contrast/gamma control menu, a vignetting ON/OFF control menu, and the like, and these menus may be configured similarly to the control menu illustrated in FIG. 6a.

In addition, the effect clip editing menu may include an effect setting menu, a transparency control menu, a trim/split menu, a rotation/mirroring control menu, and the like, and the trim/split menu, the rotation/mirroring control menu and the like may be configured similarly to the video clip editing menu. In addition, the effect setting menu and the transparency control menu may include an effect setting bar and a transparency control bar, respectively, as sub-menus, and the effect setting bar and the transparency control bar may be managed as a main editing UI and set to support the detailed control UI.

The overlay clip editing menu may include an overlay color setting menu, a transparency control menu, a trim/split menu, a rotation/mirroring control menu, a blending type setting menu, and the like. The trim/split menu, the rotation/mirroring control menu and the like may be configured similarly to the video editing menu. Also, the transparency control menu may include a transparency control bar as a sub-menu, and the transparency control bar may be managed as a main editing UI and set to support the detailed control UI.

In addition, the text clip editing menu may include a text font setting menu, a text color setting menu, a trim/split menu, a transparency control menu, a rotation/mirroring control menu, a text alignment method setting menu, a shadow ON/OFF menu, a glow ON/OFF menu, an outline ON/OFF menu, a background color ON/OFF menu, a blending type setting menu, and the like, and the trim/split menu, the transparency control menu, the rotation/mirroring control menu, and the like may be configured similarly to the video clip editing menu. In addition, the shadow ON/OFF menu, the glow ON/OFF menu, the outline ON/OFF menu, and the background color ON/OFF menu may respectively include a color control bar (e.g., R/G/B control bar) for setting a color or a transparency control bar for controlling transparency as sub-menus, and the color control bar (e.g., R/G/B control bar) or the transparency control bar may be managed as a main editing UI and set to support the detailed control UI.

In addition, the drawing clip editing menu may include a transparency control menu, a trim/split menu, a rotation/mirroring control menu, a blending type setting menu, and the like, and the trim/split menu, the rotation/mirroring control menu and the like may be configured similarly to the overlay clip editing menu. Also, the transparency control menu may include a transparency control bar as a sub-menu, and the transparency control bar may be managed as a main editing UI and set to support the detailed control UI.

In addition, the audio clip editing menu may include an audio control menu, a voice EQ control menu, a detailed volume control menu, a voice modulation control menu, a ducking ON/OFF control menu, a repeat ON/OFF control menu, a trim/split menu, and the like. The audio control menu, the voice EQ control menu, the detailed volume control menu, the voice modulation control menu, the trim/split menu, and the like may be configured similarly to a video clip editing menu.

FIG. 6 is a block diagram illustrating the configuration of a video editing UI control device according to various embodiments of the present disclosure.

Referring to FIG. 6, the video editing UI control device 60 according to an embodiment of the present disclosure may include an editing UI display unit 61, a user input checking unit 63, and an editing UI processing unit 65.

The editing UI display unit 61 may visualize and display the above-described editing UI on a display device (e.g., a display), and may check and output a menu or UI, the output of which is requested by the editing UI processing unit 65, on the display device (e.g., a display).

Here, the editing UI may include at least one menu or UI having a predetermined shape and size, and at least one menu or UI may be located and displayed in a predetermined area.

The user input checking unit 63 may check user input information such as user input generation coordinates, types of user input (e.g., single touch input, multi-touch input, single gesture input, multi-gesture input, etc.) and a gesture (single or multi gesture) input direction, based on the coordinates of the area touch-input through the display device (for example, 160 in FIG. 1), the number of touch-input areas, and a touch-input gesture, etc., and provide the checked user input information to the editing UI processing unit 65.

The editing UI processing unit 65 may check user input information provided by the user input checking unit 63 and process an operation corresponding user input information. For example, the editing UI processing unit 65 may check the user input generation coordinates, and check and process an operation corresponding to a menu or UI existing at the checked coordinates. As another example, the editing UI processing unit 65 may check a sub-menu or sub-UI of the menu or UI existing at the checked coordinates, and request output of the checked sub-menu or sub-UI to the editing UI display unit 61.

In particular, the editing UI processing unit 65 may include an editing history management UI processing unit 67 for providing an editing history management UI, and the editing history management UI processing unit 67 may include an editing event detection unit 67a, an editing history management unit 67b, and an editing history information provision unit 67c.

The editing event detection unit 67a may collect editing events generated while editing the video project, detect information corresponding thereto, and provide the detected information to the editing history management unit 67b. For example, the edit event detection unit 67a may generate and provide an event identifier capable of identifying an editing event generated through the editing UI. Also, the editing event detection unit 67a may further provide information summarizing editing content performed by the editing event. In this case, the information summarizing the editing content may be automatically configured by the editing event detection unit 67a or may be configured by user input. The editing event in an embodiment of the present disclosure may refer to each editing step of editing a video project.

The editing history management unit 67b may record and manage information about the editing history of each video project. The editing history management unit 67b may store and manage the editing event information provided from the editing event detection unit 67a. In addition, the editing history management unit 67b may configure, store, and manage index information of the editing event information. Furthermore, in configuring the editing history information, the editing history management unit 67b may include and configure information such as data creation time, data update time, data summary description, author, and the like. This editing history information may be configured in a meta data format.

For example, the editing history management unit 67b may store and manage an editing event for an editing process of a video project including editing history information (metadata) 710, index information 720 and editing event information 730 corresponding to the index information, as shown in FIG. 7, based on information received from the editing event detection unit 67a. At this time, the editing history management unit 67b may store and manage the editing process of editing event of the video project in the form of a file. The editing history information 710 includes data creation time, data update time, data summary description, author, etc. for the video project file, and the index information 720 may designate the position of the editing event in the video project file and the editing process of the video project file may be played back through the index information. The editing event information 730 may include a summary description and detailed editing content of the editing event, and the video project of the corresponding editing event may be reconstructed through the corresponding editing event information. Here, the summary description of the editing event information may include content describing the editing process of the corresponding editing event.

The editing history information provision unit 67c may change the above-described editing history information to a format that a user can check and provide it. For example, the editing history information provision unit 67c may configure an editing history provision UI and provide the editing history information to the user through the editing history provision UI.

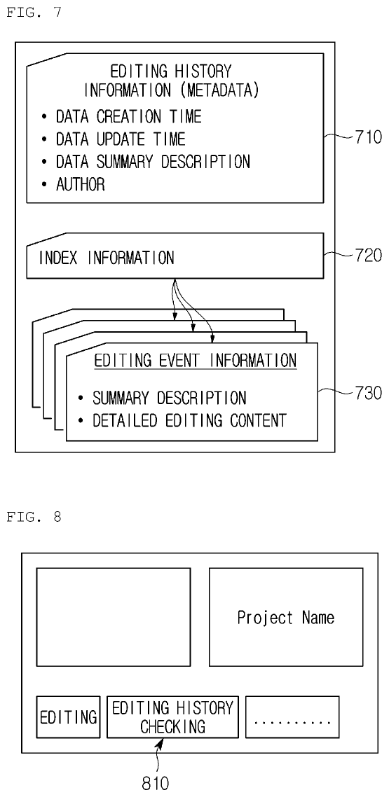

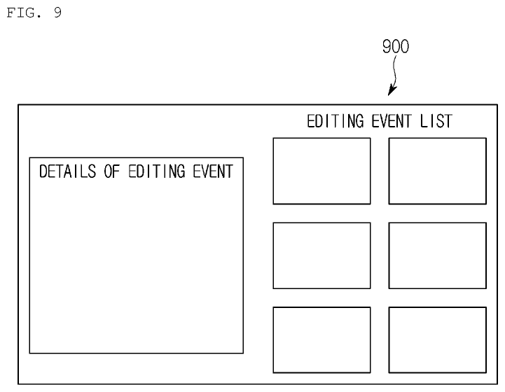

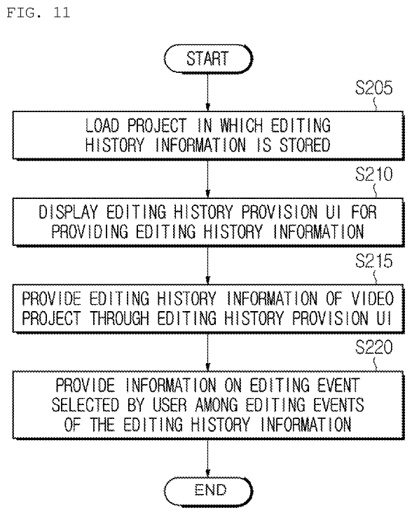

For example, the editing history information provision unit 67c may provide an editing history provision menu (810 in FIG. 8) for providing editing history information when the editing history information of the video project file is stored. In addition, as the editing history provision menu 810 is selected by the user, the editing history information provision unit 67c may configure and provide the editing history providing UI (1000 in FIG. 10) by checking the above-mentioned editing history information. Here, the editing history provision UI 1000 may be an editing process playback mode UI for playing back editing event information (730 in FIG. 7) of the video project file.

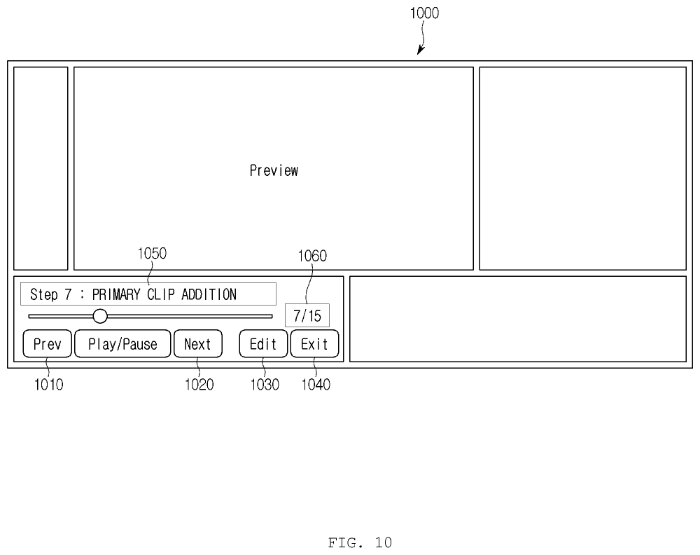

In some embodiments, as the editing history provision menu 810 is selected by the user, the editing history information provision unit 67c may provide a UI (900 in FIG. 9) for providing a list of editing event units for the corresponding video project file. The editing event list UI 900 may be configured to output details of the selected editing event when selecting the editing event units and any one editing event of the list. At this time, the editing history information provision unit 67c may configure and provide an editing history provision UI (1000 in FIG. 10) through user input in the editing event list UI 900. For example, the editing history information provision unit 67c may provide the editing history provision UI 1000, as an editing event is double-clicked in the editing event list UI 900 or a separately configured editing history provision menu is selected.

The editing history provision UI 1000 may be configured to sequentially output the editing events of the video project file. For example, the editing history provision UI 1000 includes a UI capable of selecting a previous editing event 1010, a current editing event, and a next editing event 1020, and may be configured to output details suitable for a selected event of the previous editing event 1010, the current editing event, and the next editing event 1020.

As another example, the editing history provision UI 1000 may include a playback menu of the editing event, and may be configured to automatically and sequentially play back details of the editing event as the playback menu of the editing event is selected. In this case, sequential playback may be performed based on a predetermined time unit (e.g., 1 second, 5 seconds, etc.). When sequential playback is in progress, a pause function may be provided, and in a paused state, a function of moving to a previous step, a next step, or an arbitrary step may be provided.

Furthermore, the editing history provision UI 1000 may further display the progress rate of the editing event (e.g., a progress rate of 50%, 7/15 step, 7 out of 15 steps, etc.) (1060) in providing the details of the editing event.

Furthermore, the editing history provision UI 1000 may further display a description of the current editing event, for example, “Step7: Primary Clip addition” (1050) as shown in FIG. 10, in providing the details of the editing event. At this time, the description 1050 of the current editing event may be modified by the user.

In some embodiments, when the previous editing event 1010 or the next editing event 1020 is selected by the user, the editing history information provision unit 67c may change and display the description 1050 of the editing event and the progress rate 1060 of the editing event according to the selected editing event, while outputting the details suitable for the previous editing event or the next editing event.

Furthermore, the editing history provision UI 1000 may further provide a menu 1030 requesting entry into an editing step of a selected editing event. When the menu 1030 requesting entry into the editing step is selected by the user, the editing history information provision unit 67c may configure and provide the video project in the state of the editing step corresponding to the editing event.

Furthermore, the editing history provision UI 1000 may further provide a menu 1040 for requesting exiting from the editing history provision UI 1000 and movement to a previous step. When the menu 1040 requesting movement to the previous step is selected by the user, the editing history information provision unit 67c may configure and provide the UI of FIG. 8 or 9, or provide a UI preset in the previous step.

Furthermore, the editing history provision UI 1000 may further provide a menu capable of jumping over to any one arbitrary editing event and playing back it.

As described above, the editing history information provision unit 67c may provide an editing history provision menu 810 by selecting a video project file, or provide an editing history provision menu 810 for a selected editing history information file by directly selecting the editing history information file stored for the video project file.

In addition, the editing UI processing unit 65 may determine whether or not to store the editing process through user input in the process of creating a video project, in order to store and manage the editing process of the video project, may store the editing process during editing, and end storage of the editing process during editing. In this case, the editing UI processing unit 65 may store only the editing process up to the end when the storage of the editing process is terminated during editing.

FIG. 11 is a flowchart illustrating a video editing UI control method according to various embodiments of the present disclosure.

Referring to FIG. 11, the video editing UI control method may be operated by the aforementioned electronic device (or computing device), and the operation may be initiated as a video editing application is selected and executed by user input.

When the video editing application is executed, as a project in which editing history information is stored, for example, a video project, is selected by the user, the selected video project is loaded (S205).

Here, the video project is a video project in which editing events detected in the process of editing the corresponding video project are stored and managed, and step S205 may be regarded as a process of loading a video project in which editing history information including editing events is stored. In some embodiments, the video editing UI control method may further include a process of detecting and storing an editing event of a video project, and step S205 may be a step of loading a project in which editing history information is stored by the process of detecting and storing the editing event.

When the video project is loaded in step S205, an editing history provision UI for providing the editing history information of the video project is visualized and displayed on the display device (S210). For example, in step S210, as shown in FIG. 8, as the editing history provision menu 810 is selected by the user, the editing history provision UI (1000 in FIG. 10) may be visualized and displayed.

When the editing history provision UI is displayed in step S210, the editing history information of the video project is provided through the editing history provision UI (S215). At this time, in step S215, as the video project is selected by the user, the editing history information stored for the video project may be provided through the editing history provision UI.

When the editing history information of the video project is provided through the editing history provision UI, information on an editing event selected by a user among at least one editing event included in the editing history information is provided (S220). For example, in step S220, an editing process corresponding to the editing event selected by the user may be played back and provided.

In some embodiments, in step S220, details of at least one editing event may be sequentially provided through the editing history provision UI in predetermined time units. In some embodiments, in step S220, a progress rate of the editing event may be further displayed in providing details of the editing event, and a description of the current editing event may be further displayed in providing the details of the editing event.

Furthermore, in the video editing UI control method, it may be configured and provided an editing UI in an editing state corresponding to any one editing event, as a menu (1030 in FIG. 10) for editing any one editing event is selected, on the editing history providing UI.

Although the description is omitted in the method of FIG. 11, the video editing UI control method according to the embodiment of the present disclosure may include all of the contents described in FIGS. 6 to 10, which is apparent to those skilled in the art.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various embodiments of the present disclosure are not a list of all possible combinations and are intended to describe representative aspects of the present disclosure, and the matters described in the various embodiments may be applied independently or in combination of two or more.

In addition, various embodiments of the present disclosure may be implemented in hardware, firmware, software, or a combination thereof. In the case of implementing the present invention by hardware, the present disclosure can be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

1. A video editing user interface (UI) control device, comprising:
an editing UI display unit configured to visualize and display an editing UI including an editing history provision UI on a display device;
a user input checking unit configured to check user input information based on user input touch-input through the display device; and
an editing UI processing unit configured to generate and manage editing history information based on the user input information provided by the user input checking unit and to provide the editing history information in response to input of the editing history provision UI.

2. The video editing UI control device of claim 1, wherein the editing history information comprises editing content performed by an editing event of a video project and an index of the editing event.

3. The video editing UI control device of claim 1, wherein the editing UI processing unit is configured to provide a list of editing event units of a video project through the editing history provision UI and to provide details of an editing event selected by the user.

4. The video editing UI control device of claim 1, wherein the editing UI processing unit is configured to sequentially provide details of an editing event of a video project in predetermined time units through the editing history provision UI.

5. The video editing UI control device of claim 1, wherein the editing UI processing unit is configured to, as an editing event is selected by the user on the editing history provision UI, provide information on a progress rate of an editing event indicating a position of the selected editing event.

6. The video editing UI control device of claim 1, wherein, as a menu for editing an editing event is selected by the user on the editing history provision UI, the editing UI processing unit configures and provides the editing UI in an editing state corresponding to the editing event.

7. The video editing UI control device of claim 1, wherein the editing UI processing unit comprises:
an editing event detection unit configured to detect an editing event of a video project; and
an editing history management unit configured to store and manage the editing event provided from the editing event detection unit and to manage editing history information in units of the video project.

8. The video editing UI control device of claim 7, wherein the editing UI processing unit further comprises an editing history information provision unit configured to provide the editing history information managed by the editing history management unit through the editing history provision UI, in response to the user input information.

9. A video editing user interface (UI) control method performed by a computing device comprising at least one processor, comprising:
visualizing and displaying an editing history provision UI;
providing editing history information of a video project through the editing history provision UI; and
providing information on at least one editing event included in the editing history information.

10. The video editing UI control method of claim 9, wherein the editing history information comprises editing content performed by an editing event of the video project and an index of the editing event.

11. The video editing UI control method of claim 9, wherein the providing the information on the at least one editing event comprises sequentially providing details of the at least one editing event in predetermined time units through the editing history provision UI.

12. The video editing UI control method of claim 9, further comprising, as a menu for editing any one editing event is selected by a user on the editing history provision UI, configuring and providing an editing UI in an editing state corresponding to the editing event.

13. The video editing UI control method of claim 9, further comprising detecting and storing an editing event of the video project,
wherein the providing the editing history information comprises providing editing history information stored for the video project through the editing history provision unit, as the video project is selected by a user.
